(19) United States
(12) Patent Application Publication
(10) Pub. No.: US 2026/0301130 A1
(43) Pub. Date: Oct. 1, 2026

(54) DEEP LEARNING-BASED SYSTEM AND METHOD FOR AUGMENTING VARIOUS LOW-LIGHT IMAGE DATA, CAPABLE OF ADJUSTING BRIGHTNESS

(71) Applicant: DAEGU GYEONGBUK INSTITUTE OF SCIENCE AND TECHNOLOGY, Daegu (KR)

(72) Inventors: Yong Seob LIM, Daegu (KR); Jung Hyun SEO, Incheon (KR)

(73) Assignee: DAEGU GYEONGBUK INSTITUTE OF SCIENCE AND TECHNOLOGY, Daegu (KR)

(21) Appl. No.: 19/489,361

(22) PCT Filed: May 7, 2024
(86) PCT No.: PCT/KR2024/006075

§ 371 Date: Jan. 8, 2026

(30) Foreign Application Priority Data
Jun. 2, 2023 (KR) 10-2023-0071549
Feb. 27, 2024 (KR) 10-2024-0027673

(51) Int. Cl. G06T 5/60; G06T 5/50; G06T 5/70

(52) U.S. Cl. CPC G06T 5/60; G06T 5/50; G06T 5/70

(57) ABSTRACT

A low-light image augmentation system including a training data construction unit configured to construct training data based on a first image generated in a first environment classified by an illumination level and a second image generated in a second environment having a lower illumination level than the first environment, an input image conversion unit configured to receive the first image and the second image as inputs and to convert the first image into the second image and the second image into the first image, and an operation unit configured to calculate a total loss (Loss) for training a model. The input image conversion unit is configured to convert the first image of the first environment into the second image of the second environment based on a brightness level (b) and a weight (w) using a model trained by the total loss.

### TECHNICAL FIELD

The present invention relates to a low-light image augmentation system based on a deep learning network having a CycleGAN architecture, wherein a brightness level of a result image is set according to a user-input brightness level, noise is reduced using a feature attention (self-attention) scheme, and low-light image augmentation is performed by converting a bright image generated under a bright condition, such as a daytime condition, into a low-illumination image corresponding to a low-light condition, such as a nighttime condition.

### BACKGROUND ART

Datasets used to train image deep learning models applied to an autonomous vehicle perception field are mostly composed of bright images captured under daytime environments, and thus lack low-illumination data captured under nighttime environments. As a result, recognition performance degradation occurs for low-light images as compared to images captured under daytime conditions.

Low-light image data augmentation is an image generation approach intended to address performance degradation issues in specific situations caused by insufficient existing datasets.

Most image generation models are composed of an encoder and a decoder, such as a GAN (Generative Adversarial Network). The encoder extracts features from an input image, and the decoder generates a result image using the features extracted by the encoder.

In particular, a CycleGAN-based generation model improves image conversion performance through the introduction of a generator and a discriminator, and allows relatively flexible constraints on pairs of input images and result images, thereby enabling use in various fields and situations. However, when low-light image augmentation is performed using CycleGAN or other image generation models, excessive noise may occur, and a brightness level of a result image may be arbitrarily determined.

In addition, a Transformer, which achieves high performance in natural language processing, provides improved results compared to conventional methods by using a self-attention scheme. Recently, self-attention schemes have been applied not only to natural language processing but also to CNN (Convolutional Neural Network) architectures in forms such as non-local attention and channel attention, thereby achieving improved performance in image classification and detection tasks.

### DETAILED DESCRIPTION OF THE INVENTION

### Technical Problem

The present invention is directed to reducing noise in a result image by using a feature attention (self-attention) scheme during operation of a low-light image augmentation system, and to setting a brightness level of the result image based on a user-input brightness level, thereby obtaining diverse and accurate low-light images and addressing data insufficiency issues.

### DETAILED DESCRIPTION OF THE INVENTION

### Technical Solution

According to an embodiment, a low-light image augmentation system includes a training data construction unit configured to construct training data based on a first image generated in a first environment classified by an illumination level and a second image generated in a second environment having a lower illumination level than the first environment, an input image conversion unit configured to receive the first image and the second image as inputs and to convert the first image into the second image and the second image into the first image, and an operation unit configured to calculate a total loss (Loss) for training a model by comparing at least one of the converted first image or the converted second image with an input image. The input image conversion unit is configured to convert the first image of the first environment into the second image of the second environment based on a brightness level (b) and a weight (w) using a model trained by the total loss.

According to an embodiment, the low-light image augmentation system may further include an image discrimination unit configured to determine whether each of the converted images corresponds to the first image or the second image.

According to an embodiment, the low-light image augmentation system may further include a feature attention (self-attention) unit configured to perform noise reduction by separating a background of the converted first image or the converted second image.

According to an embodiment, the low-light image augmentation system may further include a brightness setting unit configured to set a brightness level of a result image when calculating the total loss.

According to an embodiment, the training data construction unit is configured to construct a first image set and a second image set by extracting N data samples from a first situation dataset (X) of the first environment and N data samples from a second situation dataset (Y) of the second environment, respectively, such that the first image set includes N first images {xᵢ}^{N}ᵢ_{⁼¹} where xᵢ∈X, and the second image set includes N second images {yᵢ}ᵢ_{⁼¹}^{N} where yᵢ∈Y.

According to an embodiment, the input image conversion unit is configured to receive, as inputs, N first images {xᵢ}ᵢ_{^{−1}}^{N} where xᵢ∈X and N second images {yᵢ}ᵢ_{⁼¹}^{N} where yᵢ∈Y using an image conversion model based on a CycleGAN model with added brightness control and feature attention functions, to convert each of the N first images into a corresponding second image using a generator GXY, and to convert each of the N second images into a corresponding first image using a generator GYX.

According to an embodiment, the image discrimination unit is configured to perform a task of distinguishing a first image converted from the second image from a real first image of an actual environment, and to perform a task of distinguishing a second image converted from the first image from a real second image of the actual environment.

According to an embodiment, the feature attention unit includes a non-local neural network added to structures of generators GXY and GYX and discriminators DX and DY of a CycleGAN model.

According to an embodiment, the operation unit is configured to calculate the total loss (Loss) including an adversarial loss presented in CycleGAN, a cycle consistency loss, and a brightness control loss.

According to an embodiment, the operation unit is configured to update parameters (Parameter) of generators GXY and GYX and discriminators DX and DY using the calculated total loss.

According to an embodiment, the brightness setting unit is configured to set the brightness level (b) and the weight (w) such that a brightness level of the result image converges to a predetermined value when calculating the brightness control loss.

According to an embodiment, a method of operating the low-light image augmentation system includes collecting data including a first image generated in a first environment classified by an illumination level and a second image generated in a second environment having a lower illumination level than the first environment, setting an environment for training an image conversion model, inputting the collected data into the trained image conversion model, dividing the input data into a source domain image (X) and a target domain image (Y), performing image conversion using a generator GXY configured to convert the source domain image into the target domain image and a generator GYX configured to convert the target domain image into the source domain image, calculating a total loss based on a loss function set for training the system, and generating the trained image conversion model using the calculated total loss.

According to an embodiment, setting the environment for training the image conversion model includes setting training parameters and setting a target brightness for a result image.

### Effects of the Invention

According to an embodiment, low-light image augmentation is performed with improved performance by converting a bright image generated under a daytime environment into a low-illumination image corresponding to a nighttime environment, and a brightness level of the low-light image may be adjusted.

The effects of the present invention are not limited to the effects described above, and other effects not explicitly described herein will be clearly understood by those skilled in the art from the present specification and the accompanying drawings.

### BRIEF DESCRIPTION OF THE DRAWINGS

FIG. 1 is a diagram illustrating a deep learning-based low-light image augmentation system with adjustable brightness according to an embodiment of the present invention.

FIG. 2 is a diagram illustrating a training process of an image conversion model configured to reduce noise generated during low-light image augmentation and to convert a result image to have a user-input brightness level.

FIG. 3 is a diagram illustrating a process in which a bright image is converted into a low-light image by a trained image conversion model.

FIG. 4 is a graph illustrating a brightness level of a result image generated according to a brightness level set by a brightness setting unit.

FIG. 5 is a graph illustrating a brightness level of a result image generated according to a weight set by the brightness setting unit.

FIG. 6 is a diagram illustrating result images produced by an image conversion model to which a CycleGAN model, a feature attention unit, and a brightness controller are applied.

FIG. 7 is a diagram illustrating result images produced by applying various image conversion models (CycleGAN, DRIT, TSIT, MUNIT) and an image conversion model including a feature attention unit and a brightness controller to a bright input image (KITTI).

### BEST MODE FOR CARRYING OUT THE INVENTION

The embodiments according to the concept of the present invention disclosed herein are provided for illustrative purposes only, and specific structural or functional descriptions thereof are merely examples intended to explain the embodiments according to the concept of the present invention. The embodiments according to the concept of the present invention may be implemented in various forms and are not limited to the embodiments described herein.

Since the embodiments according to the concept of the present invention may be subject to various modifications and may take various forms, the embodiments are illustrated in the drawings and described in detail in the present specification. However, this is not intended to limit the embodiments according to the concept of the present invention to specific disclosed forms, and it should be understood that the present invention includes all modifications, equivalents, and alternatives falling within the spirit and technical scope of the present invention.

Terms such as “first” and “second” may be used to describe various components, but such components should not be limited by these terms. These terms are used only to distinguish one component from another. For example, a first component may be referred to as a second component without departing from the scope of the present invention, and similarly, a second component may be referred to as a first component.

When an element is described as being “connected to” or “coupled to” another element, it should be understood that the element may be directly connected or coupled to the other element, or intervening elements may be present therebetween. In contrast, when an element is described as being “directly connected to” or “directly coupled to” another element, it should be understood that no intervening elements are present. Expressions describing relationships between elements, such as “between” and “directly between” or “adjacent to” and “directly adjacent to,” should be interpreted in a similar manner.

The terminology used herein is for the purpose of describing particular embodiments only and is not intended to limit the present invention. As used herein, singular forms are intended to include plural forms as well, unless the context clearly indicates otherwise. In the present specification, terms such as “comprise,” “include,” or “have” specify the presence of stated features, numbers, steps, operations, elements, components, parts, or combinations thereof, but do not preclude the presence or addition of one or more other features, numbers, steps, operations, elements, components, parts, or combinations thereof.

Unless otherwise defined, all terms used herein, including technical and scientific terms, have the same meaning as commonly understood by one of ordinary skill in the art to which the present invention pertains. Terms defined in generally used dictionaries should be interpreted as having meanings consistent with their meanings in the context of the relevant art and should not be interpreted in an idealized or overly formal sense unless expressly defined herein.

Hereinafter, embodiments will be described in detail with reference to the accompanying drawings. However, the scope of the patent application is not limited or restricted by these embodiments. Like reference numerals refer to like elements throughout the drawings.

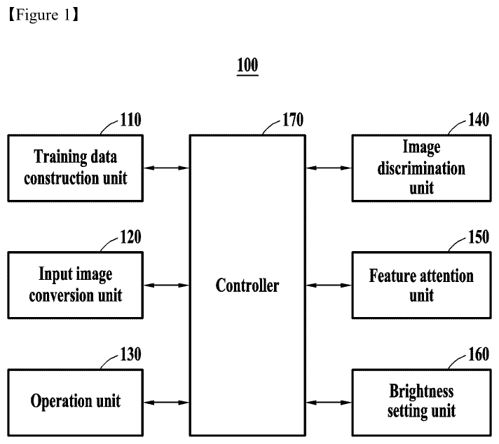

FIG. 1 is a block diagram briefly illustrating a deep learning-based low-light image augmentation system (100) with adjustable brightness according to an embodiment of the present invention.

In the present invention, a first environment and a second environment are distinguished based on an illumination level. Hereinafter, for purposes of explanation, the first environment is exemplified as a bright daytime environment, and the second environment is exemplified as a nighttime environment having a lower illumination level compared to the bright daytime environment.

In addition, a first image acquired in the first environment may be interpreted as a bright image generated in the daytime environment, and a second image acquired in the second environment may be interpreted as a low-illumination image generated in the nighttime environment.

According to an embodiment, the low-light image augmentation system (100) is configured to convert a bright image generated in the daytime environment into a low-illumination image corresponding to the nighttime environment, thereby performing low-light image augmentation with improved performance and adjusting a brightness level of the low-light image.

To this end, according to an embodiment, the low-light image augmentation system (100) may include a training data construction unit (110), an input image conversion unit (120), an operation unit (130), an image discrimination unit (140), a feature attention unit (150), and a brightness setting unit (160).

The training data construction unit (110) is configured to construct training data based on a bright image generated in a daytime environment classified by an illumination level and a low-illumination image generated in a nighttime environment having a lower illumination level than the daytime environment.

The training data construction unit (110) constructs bright images ({xᵢ}^{N}ᵢ_{⁼¹} where xᵢ∈X) and low-illumination images ({yᵢ}^{N}ᵢ_{⁼¹} where yᵢ∈Y) by extracting N data samples from a first situation dataset (X) of a daytime environment and N data samples from a second situation dataset (Y) of a nighttime environment.

In one example, the bright images and the low-illumination images are randomly extracted from the respective situation datasets.

The input image conversion unit (120) is configured to receive the bright images and the low-illumination images as inputs and to convert the bright images into low-illumination images and the low-illumination images into bright images.

The operation unit (130) is configured to calculate a total loss (Loss) for training a model by comparing at least one of the converted bright images or the converted low-illumination images with an input image.

For example, the operation unit (130) may calculate the total loss (Loss) including an adversarial loss presented in CycleGAN, a cycle consistency loss, and a brightness control loss.

The operation unit (130) is configured to update parameters (Parameter) of generators GXY and GYX and discriminators DX and DY using the calculated total loss.

For example, the operation unit (130) may include an adversarial loss, a cycle consistency loss, and a brightness control loss, and training is performed by updating parameters (Parameter) of generators GXY and GYX and discriminators DX and DY using the calculated losses.

The input image conversion unit (120) is configured to convert a bright image of a daytime environment into a low-illumination image of a nighttime environment based on a brightness level (b) and a weight (w) using a model trained by the total loss.

The input image conversion unit (120) is configured to receive, as inputs, N bright images ({xᵢ}^{N}ᵢ_{⁼¹} where xᵢ∈X) and N low-illumination images ({yᵢ}^{N}ᵢ_{⁼¹} where yᵢ∈Y) using an image conversion model based on a CycleGAN model with added brightness control and feature attention functions, to convert the bright images into low-illumination images using a generator GXY, and to convert the low-illumination images into bright images using a generator GYX.

In the input image conversion unit (120), a brightness control loss function and a feature attention map are added based on a generator of CycleGAN. In general, CycleGAN performs training using unpaired source domain images and target domain images, and generates result images by reflecting information of the target domain while preserving information of the source domain. In the present invention, unpaired N bright images ({xᵢ}^{N}ᵢ_{⁼¹} where xᵢ∈X) and N low-illumination images ({yᵢ}^{N}ᵢ_{⁼¹} where yᵢ∈Y) are input, such that a generator GXY converts the bright images into low-illumination images and a generator GYX converts the low-illumination images into bright images.

For example, the generator GXY includes a feature attention map added to a conventional CycleGAN generator and is trained using a loss function including a brightness control loss, thereby generating low-illumination images having a specific brightness level.

The image discrimination unit (140) is configured to determine whether each converted image corresponds to a bright image or a low-illumination image.

The image discrimination unit (140) is configured to perform a task of distinguishing a bright image converted from a low-illumination image from a bright image of an actual environment, and to perform a task of distinguishing a low-illumination image converted from a bright image from a low-illumination image of the actual environment.

In one example, the image discrimination unit includes a feature attention map added based on a CycleGAN discriminator. In general, a discriminator of CycleGAN performs a role of determining whether each of an input image and a result image belongs to a corresponding domain. In the present invention, outputs of the discriminator are DY(GXY(X)) and DX(GYX(Y)), and based on the outputs, a loss function is calculated and reflected in training of each discriminator, thereby improving discrimination accuracy.

The feature attention unit (150) is configured to perform noise reduction by separating a background of a converted bright image or a converted low-illumination image.

In particular, the feature attention unit (150) may include a non-local neural network added to structures of generators GXY and GYX and discriminators DX and DY of a CycleGAN model.

In one example, the feature attention unit (150) may include Self-Attention. In general, Self-Attention is a scheme used in a Transformer that shows high performance in natural language processing, and calculates similarity between a given query (Query) and all keys (Key), and reflects corresponding values (Value) mapped to the keys using the similarity as a weight.

In the present invention, the feature attention unit (150) performs a role of separating background information and image-intrinsic information by applying a non-local neural network, which is a form of applying Self-Attention to a CNN. Through this approach, noise such as erroneously converted artifacts frequently occurring in a result image is reduced, thereby generating a low-illumination image similar to an actual nighttime environment.

The brightness setting unit (160) is configured to set a brightness level of a result image when calculating the total loss.

The brightness setting unit (160) is configured to set a brightness level (b) and a weight (w) such that the brightness level of the result image converges to a predetermined value when calculating a brightness control loss.

For example, when calculating the brightness control loss, the brightness setting unit (160) may set a user-input brightness level (b) and a weight (w). Based on the set values, the brightness level of the result image may converge to a predetermined value.

In addition, according to an embodiment, the low-light image augmentation system (100) may further include a controller (170).

The controller (170) may be interpreted as a Central Processing Unit (CPU), and may perform various computations and process data within the system.

In particular, the controller (170) may read instructions from a memory, interpret the instructions, and execute the instructions, and may perform arithmetic operations such as addition, subtraction, multiplication, and division.

In addition, the controller (170) may process data storage and retrieval by reading data from the memory and storing results of computations back into the memory.

Further, the controller (170) may manage execution flow of a program, and in particular, may control program flow using instructions such as conditional statements (if-else) and loop statements (for, while). In addition, the controller (170) may include internal registers that are small and fast storage devices, and the registers may be used to temporarily store data or perform computations.

The controller (170) may handle external events or exception situations and take appropriate actions, and may access data and instructions at high speed using cache memory that is faster than main memory.

Furthermore, the controller (170) may use a system bus to communicate with a memory or input/output devices, and may provide various power management functions to minimize power consumption.

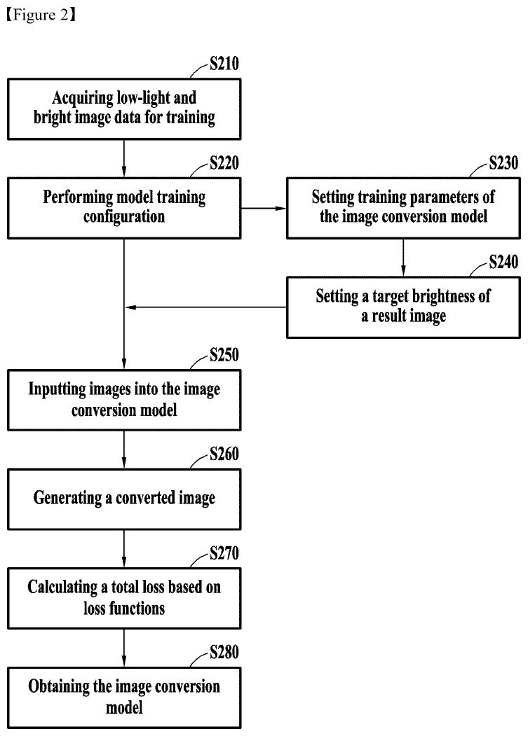

FIG. 2 is a diagram illustrating a training process of an image conversion model configured to reduce noise generated during low-light image augmentation and to convert a result image to have a user-input brightness level according to an embodiment of the present invention.

Referring to FIG. 2, in step 210, a dataset of the low-light image augmentation system may be acquired from a camera of an autonomous vehicle under a bright daytime environment and a low-illumination nighttime environment.

In step 220, configuration values for training the low-light image augmentation system may be set. Since the image conversion model used in the low-light image augmentation system is configured based on a CycleGAN model, a learning rate, an optimization scheme (Optimizer), and a number of training iterations (Epoch) may be set, and additionally, a brightness level (b) and a weight (w) may be set by an added brightness control loss function.

In step 230, as training parameters of the image conversion model, the learning rate may be set to 0.0002, the optimization scheme may be set to an Adam optimizer, and the number of training iterations may be set to 200 epochs.

In step 240, a brightness level of a result image generated by the image conversion model may be set to a predetermined value.

The brightness level is represented using a Y value in a YCbCr domain, which is commonly used in image processing, and has a range of [0-255]. A conversion equation from an RGB domain image to a YCbCr domain image is as follows.

$$Y = 0.299 R + 0.587 G + 0.114 B \qquad [ Equation 1 ]$$

$$Cb = - 0.169 R - 0.331 G + 0.499 B + 128$$

$$Cr = 0.499 R - 0.418 G - 0.0813 B + 128$$

Here, R, G, and B values represent respective channel values in an RGB domain image, and Y, Cb, and Cr values represent respective channel values in a YCbCr domain image.

A Y value (p) desired by a user is normalized to a range of [−1~1] through the equation below to define a setting value (q). Here, as the value decreases, a darker image is generated, and as the value increases, a brighter image is generated.

$$q = \frac{p}{255} \times 2 - 1 \qquad [ Equation 2 ]$$

In step 250, the low-light image augmentation system may input the images obtained in step 210 into the model set in step 220.

In step 260, the low-light image augmentation system divides the images input in step 250 into a source domain image (X) and a target domain image (Y), and performs image conversion using a generator GXY configured to convert the source domain image into the target domain image and a generator GYX configured to convert the target domain image into the source domain image. Accordingly, a target domain image generated by conversion from the source domain, GXY(X), and a source domain image generated by conversion from the target domain, GYX(Y), may be generated.

In step 270, the low-light image augmentation system may calculate a total loss based on a loss function set for training the low-light image augmentation system. An equation for the overall loss function is as follows.

$$L ( {G}_{XY} , {D}_{Y} , X , Y ) = {λ}_{1} {L}_{adv} ( {G}_{XY} , {D}_{Y} , X , Y ) + {λ}_{2} {L}_{adv} ( {G}_{YX} , {D}_{X} , X , Y ) + {λ}_{3} {L}_{cyc} ( {G}_{XY} , {G}_{YX} ) + {λ}_{4} {L}_{ctrl} ( X ) \qquad [ Equation 3 ]$$

In Equation 3, λ₁, λ₂, λ₃, and λ₄ are weighting factors used to balance contribution ratios of respective loss function values. The total loss function includes an adversarial loss, a cycle consistency loss, and a brightness control loss (Y-control loss), which may be represented as L_{adv}, L_{cyc}, and L_{ctrl}, respectively.

The adversarial loss and the cycle consistency loss are loss functions presented in CycleGAN, and are configured to assist a source domain image in being more effectively converted into a target domain image.

An adversarial loss function L_{adv}(G_{XY}, D_{Y}, X, Y)calculates a loss based on a generator GXY, a discriminator DY, a source domain image X, and a target domain image Y. As an image conversion model is trained, parameters are updated to minimize the adversarial loss function. In this process, the generator GXY is trained to generate a result image that is highly similar to the target domain image Y from the source domain image X, and the discriminator DY is trained to distinguish whether an image GXY(X) generated by the generator GXY corresponds to the target domain image Y.

In this process, the generator is trained with an objective of generating images that are indistinguishable from real images such that the discriminator is unable to distinguish between an input image and a generated image. In contrast, the adversarial loss function L_{adv}(G_{XY}, D_{Y}, X, Y)is trained in an opposite manner.

A cycle consistency loss function L_{cyc}(G_{XY}, G_{YX}) calculates a loss using generators GXY and GYX. Specifically, a source domain image X is converted into a target domain image through the generator GXY, and a generated image GXY(X) is then converted back into a source domain image through the generator GYX, i.e., GYX(GXY(X)). A loss calculated based on a Euclidean distance between the reconstructed image and the input source domain image X is obtained. In addition, a target domain image Y is converted into a source domain image through the generator GYX, and a generated image GYX(Y) is then converted back into a target domain image through the generator GXY, i.e., GXY(GYX(Y)). A loss calculated based on a Euclidean distance between the reconstructed image and the input target domain image Y is obtained. The cycle consistency loss is calculated by summing the losses calculated based on the Euclidean distances.

A brightness control loss function calculates a loss based on an image GXY(X) generated by converting a source domain image X into a target domain image through a generator GXY. The image GXY(X) generated as the target domain image and a setting value (q) set in step 240 are converted into a YCbCr image domain, and a loss is calculated based on a Euclidean distance between the setting value (q) and an average of Y values over all pixels of the image.

Specifically, after converting the generated image GXY(X) into the YCbCr domain, an average of Y values for all pixels of the image is calculated as follows:

$${\sum }_{i = 1}^{h} {\sum }_{j = 1}^{w} {T ( {G}_{XY} ( X ) )}_{i , j}$$

where T(·)denotes a function that represents a Y value after conversion to a YCbCr domain image, and hand w denote a height and a width of the image, respectively. The brightness control loss is calculated based on a Euclidean distance between the calculated average Y value and the setting value (q).

In step 280, a trained image conversion model for the low-light image augmentation system may be obtained. Using the obtained model, a bright image corresponding to a daytime environment may be converted into a low-illumination image corresponding to a nighttime environment.

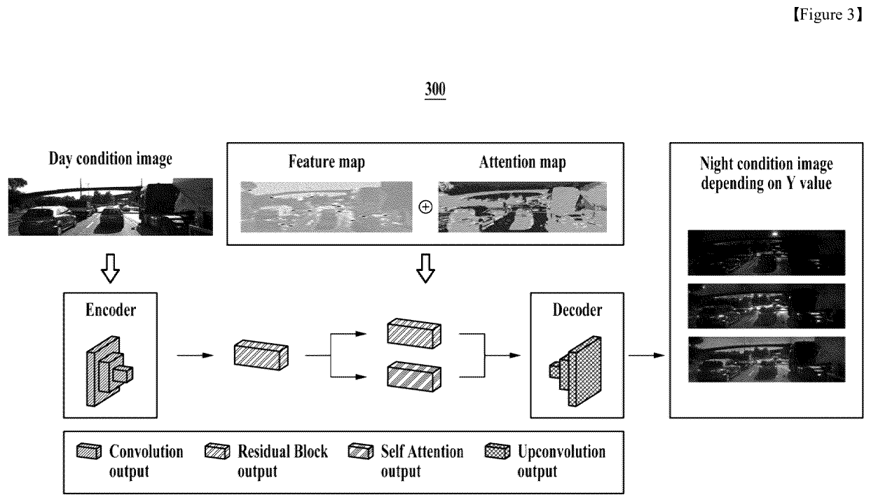

FIG. 3 is a diagram illustrating a process in which a bright image is converted into a low-illumination image by the trained image conversion model according to an embodiment of the present invention.

In one example, the image conversion model may include an encoder, a residual block, a feature attention (Self-attention) unit, and a decoder.

In one example, the encoder is configured to receive a bright image corresponding to a daytime environment as an input and to extract a feature map.

In one example, the feature map is a result obtained by applying a convolution scheme to an input image in the encoder.

In one example, the residual block learns a difference between a bright image and a low-illumination image during a process of converting the bright image corresponding to a daytime environment into a low-illumination image corresponding to a nighttime environment. Through this process, the residual block extracts features of the low-illumination image from the bright image and applies the extracted features to a converted image. Accordingly, the residual block learns information required for the image conversion model to extract features of the low-illumination image from the bright image and to apply the extracted features to convert the bright image into the low-illumination image.

In one example, the feature attention unit adds Self-attention to the image conversion model and obtains an attention map by passing the feature map obtained from the residual block through the feature attention unit.

In one example, the Self-attention added to the image conversion model may be implemented as a non-local neural network.

In one example, the non-local neural network is applied over an entire spatial domain of the image.

Here, the entire spatial domain refers to all pixels of the image.

An operation equation of the non-local neural network is as follows.

$${r}_{i} = \frac{1}{C ( x )} {\sum }_{∀ j} u ( {x}_{i} , {x}_{j} ) v ( {x}_{j} ) \qquad [ Equation 4 ]$$

Here, i denotes a position of a specific pixel in an image, and j denotes positions of other pixels in the image excluding the position i. A function u obtains a degree of correlation between information at the pixel position i and information at the pixel position j, and a function v provides information indicating a degree of correlation between information at the pixel position j and all other information. In Equation 4, C denotes a term calculated for normalization. An output of the non-local neural network provides a role of each pixel over an entire image, and such information may reduce noise when generating a low-illumination image.

In one example, a decoder is configured to receive an output of the feature attention unit as an input and to generate a low-illumination image. The generation is performed based on an up-convolution scheme.

In one example, the image conversion model is configured to generate a low-illumination image having a set brightness level, and a trained model obtained by setting a different brightness level is configured to generate a low-illumination image having the corresponding brightness level. Through this approach, low-illumination images having multiple brightness levels may be generated, and such trained models may be used to generate low-illumination images having various brightness levels.

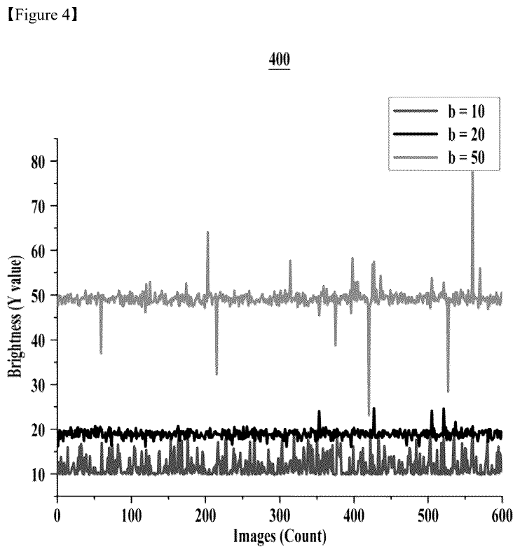

FIG. 4 is a graph illustrating a brightness level of a result image generated according to a brightness level set by the brightness setting unit in accordance with an embodiment of the present invention.

In one example, in step 220 of FIG. 2, the weight (w) may be fixed while the brightness level (b) is set to different values. Here, the weight (w) may be set to 10.

Referring to results shown in FIG. 4, when the brightness level (b) is set to 10, brightness levels of the generated low-illumination images are shown to converge to 10; when the brightness level (b) is set to 20, brightness levels of the generated low-illumination images are shown to converge to 20; and when the brightness level (b) is set to 50, brightness levels of the generated low-illumination images are shown to converge to 50.

These results demonstrate that an image conversion model trained by additionally including a brightness control loss is capable of causing a brightness level of a result image to converge to a predetermined value.

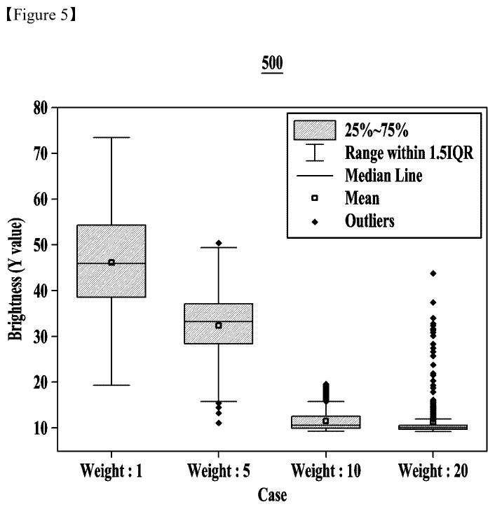

FIG. 5 is a graph illustrating a brightness level of a result image generated according to a weight set by the brightness setting unit in accordance with an embodiment of the present invention.

In one example, in step 220 of FIG. 2, the brightness level (b) may be fixed while the weight (w) is set to different values. Here, the brightness level (b) may be set to 10.

Referring to results shown in FIG. 5, when the weight (w) is set to 1, an average brightness level of the generated low-illumination images is shown to converge to approximately 45, and a deviation is observed to be very large as compared to results obtained with other weights. When the weight (w) is set to 5, an average brightness level of the generated low-illumination images is shown to converge to approximately 33, and a deviation is observed to be large as compared to results obtained with other weights. When the weight (w) is set to 10, an average brightness level of the generated low-illumination images is shown to converge to approximately 10, and a deviation is observed to be small as compared to results obtained with other weights. When the weight (w) is set to 20, an average brightness level of the generated low-illumination images is shown to converge to approximately 10, and although a deviation is observed to be very small as compared to results obtained with other weights, a large number of outlier brightness levels are observed.

Accordingly, these results demonstrate that setting the weight (w) to 10 provides an optimal condition for converting a bright image into a low-illumination image.

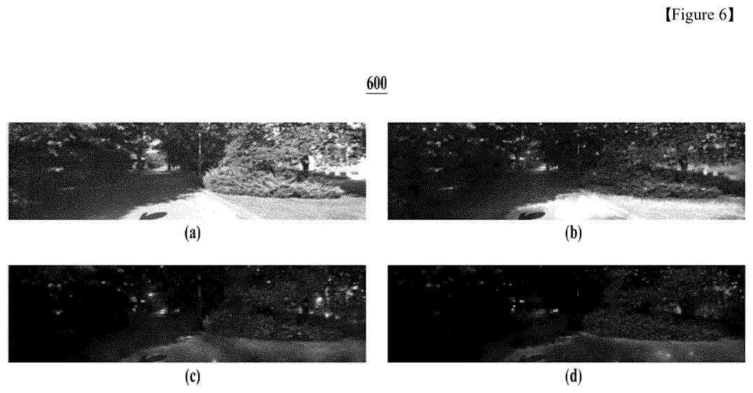

FIG. 6 is a diagram illustrating result images produced by an image conversion model to which a CycleGAN model, a feature attention unit, and a brightness controller are applied according to an embodiment of the present invention.

In one example, FIG. 6(a) is an image representing an original bright image captured under a daytime condition, and is an input image of the image conversion model.

FIG. 6(b) is a result image obtained by converting the input image of FIG. 6(a) into a low-illumination image corresponding to a nighttime condition using the image conversion model based on CycleGAN. FIG. 6(c) is a result image obtained when only a brightness controller is added to the CycleGAN-based image conversion model, such that a brightness level of the converted low-illumination image converges to a predetermined value. As compared with the result of FIG. 6(b), FIG. 6(c) shows that a brightness level is darker and more uniformly distributed, similar to an actual nighttime environment.

FIG. 6(d) is a result image obtained when both the brightness controller and the feature attention unit are added to the CycleGAN-based image conversion model to convert the image into a low-illumination image. As compared with FIG. 6(c), it can be confirmed that noise in the result image is reduced. In addition, as compared with the result of FIG. 6(b) obtained using only CycleGAN, FIG. 6(d) is more similar to an actual nighttime environment, indicating that the image conversion model has been improved for the low-light image augmentation system.

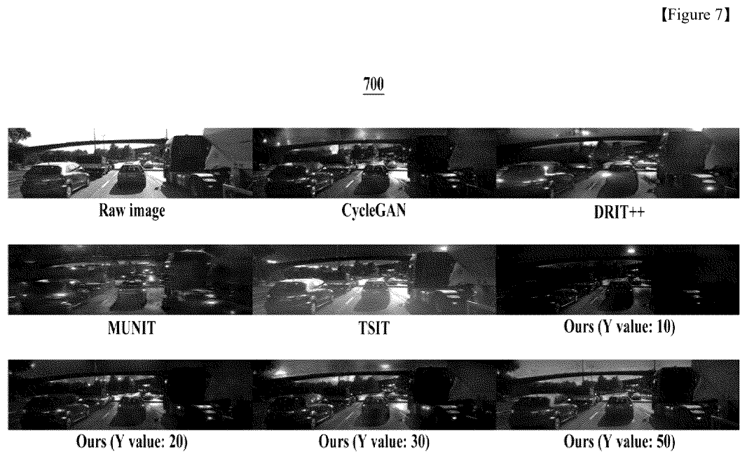

FIG. 7 is a diagram illustrating result images produced by applying various existing image conversion models (CycleGAN, DRIT++, TSIT, and MUNIT) and an image conversion model including a feature attention unit and a brightness controller to a bright input image (KITTI) according to an embodiment of the present invention.

In one example, a Raw image in FIG. 7 represents an original bright image captured under a daytime condition and is an input image of the image conversion model. Ours denotes a model obtained by adding a brightness controller and a feature attention unit to CycleGAN, and a Y value represents a brightness level (b) set by the brightness controller.

In one example, results produced by the various image conversion models (CycleGAN, DRIT++, TSIT, and MUNIT) shown in FIG. 7 do not exhibit convergence of a brightness level to a predetermined value, and a large amount of noise such as artifacts is observed in the images. In contrast, Ours enables brightness adjustment through the Y value, and as compared with results of the other image conversion models, artifacts are significantly reduced, thereby providing results more similar to an actual nighttime environment. These results indicate that an image conversion model including the brightness controller and the feature attention unit is suitable for a low-light image augmentation system.

Accordingly, by using the present invention, a bright image corresponding to a daytime environment can be converted into a low-illumination image corresponding to a nighttime environment, thereby performing low-light image augmentation with improved performance and adjusting a brightness level of the low-illumination image.

The apparatuses described above may be implemented using hardware components, software components, or a combination of hardware components and software components. For example, the apparatuses and units described in the embodiments may be implemented using one or more general-purpose computers or special-purpose computers, such as, but not limited to, a processor, a controller, an arithmetic logic unit (ALU), a digital signal processor (DSP), a microcomputer, a field programmable array (FPA), a programmable logic unit (PLU), a microprocessor, or any other device capable of executing and responding to instructions.

A processing device may execute an operating system (OS) and one or more software applications executed on the operating system. In addition, the processing device may access, store, manipulate, process, and generate data in response to execution of software. Although the processing device is described as being singular for convenience of explanation, those skilled in the art will appreciate that the processing device may include a plurality of processing elements and/or a plurality of types of processing elements. For example, the processing device may include a plurality of processors, or a combination of one processor and one controller. Other processing configurations, such as a parallel processor configuration, are also possible.

Software may include a computer program, code, instructions, or a combination thereof, and may configure a processing device to operate as desired or may independently or collectively instruct the processing device. Software and/or data may be permanently or temporarily embodied in any type of machine, component, physical device, virtual device, computer storage medium or device, or in a propagated signal wave, in order to be interpreted by or to provide instructions or data to the processing device. The software may be distributed over network-connected computer systems and stored or executed in a distributed manner. Software and data may be stored in one or more computer-readable recording media.

The methods according to the embodiments may be implemented in the form of program instructions executable through various computer means and recorded on computer-readable media. The computer-readable media may include program instructions, data files, data structures, or combinations thereof. The program instructions recorded on the media may be specially designed and configured for the embodiments or may be instructions that are known and available to those skilled in the art of computer software. Examples of computer-readable recording media include magnetic media such as hard disks, floppy disks, and magnetic tapes; optical recording media such as CD-ROMs and DVDs; magneto-optical media such as floptical disks; and hardware devices specially configured to store and execute program instructions, such as ROM, RAM, and flash memory. Examples of program instructions include machine code generated by a compiler as well as high-level language code executable by a computer using an interpreter or the like. The hardware devices described above may be configured to operate as one or more software modules in order to perform the operations of the embodiments, and vice versa.

Although the embodiments have been described with reference to limited drawings, those skilled in the art will appreciate that various modifications and variations may be made based on the above description. For example, the described techniques may be performed in an order different from the described order, and/or components of the described systems, structures, apparatuses, circuits, and the like may be combined or assembled in a different manner from the described manner, or may be replaced or substituted by other components or equivalents, while still achieving appropriate results.

Accordingly, other implementations, other embodiments, and equivalents to the claims are intended to fall within the scope of the claims set forth below.

1. A low-light image augmentation system, comprising:
a training data construction unit configured to construct training data based on a first image generated in a first environment classified by an illumination level and a second image generated in a second environment having a lower illumination level than the first environment;
an input image conversion unit configured to receive the first image and the second image as inputs and to convert the first image into the second image and the second image into the first image; and
an operation unit configured to calculate a total loss for training a model by comparing at least one of the converted first image or the converted second image with an input image,
wherein the input image conversion unit is configured to convert the first image of the first environment into the second image of the second environment based on a brightness level (b) and a weight (w) using a model trained by the total loss.

2. The low-light image augmentation system of claim 1, further comprising:
an image discrimination unit configured to determine whether each of the converted images corresponds to the first image or the second image.

3. The low-light image augmentation system of claim 1, further comprising:
a feature attention unit configured to perform noise reduction by separating a background of the converted first image or the converted second image.

4. The low-light image augmentation system of claim 1, further comprising:
a brightness setting unit configured to set a brightness level of a result image when calculating the total loss.

5. The low-light image augmentation system of claim 1,
wherein the training data construction unit is configured to construct a first image set and a second image set by extracting N data samples from a first situation dataset (X) of the first environment and N data samples from a second situation dataset (Y) of the second environment, respectively,
such that the first image set includes N first images {xᵢ}^{N}ᵢ_{⁼¹} where xᵢ∈X, and the second image set includes N second images {yᵢ}^{N}ᵢ_{⁼¹} where yᵢ∈Y.

6. The low-light image augmentation system of claim 1,
wherein the input image conversion unit is configured to:
receive, as inputs, N first images {xᵢ}^{N}ᵢ_{⁼¹} where xᵢ∈X and N second images {yᵢ}^{N}ᵢ_{⁼¹} where yᵢ∈Y using an image conversion model based on a CycleGAN model with added brightness control and feature attention functions;
convert each of the N first images into a corresponding second image using a generator GXY; and
convert each of the N second images into a corresponding first image using a generator GYX.

7. The low-light image augmentation system of claim 1, wherein the image discrimination unit is configured to:
perform a task of distinguishing a first image converted from the second image from a real first image of an actual environment; and
perform a task of distinguishing a second image converted from the first image from a real second image of the actual environment.

8. The low-light image augmentation system of claim 3, wherein the feature attention unit includes a non-local neural network added to structures of generators GXY and GYX and discriminators DX and DY of a CycleGAN model.

9. The low-light image augmentation system of claim 1, wherein the operation unit is configured to calculate the total loss including:
an adversarial loss presented in CycleGAN;
a cycle consistency loss; and
a brightness control loss.

10. The low-light image augmentation system of claim 1, wherein the operation unit is configured to update parameters of generators GXY and GYX and discriminators DX and DY using the calculated total loss.

11. The low-light image augmentation system of claim 4, wherein the brightness setting unit is configured to set the brightness level (b) and the weight (w) such that a brightness level of the result image converges to a predetermined value when calculating the brightness control loss.

12. A method of operating a low-light image augmentation system, comprising:
collecting data including a first image generated in a first environment classified by an illumination level and a second image generated in a second environment having a lower illumination level than the first environment;
setting an environment for training an image conversion model;
inputting the collected data into the trained image conversion model;
dividing the input data into a source domain image (X) and a target domain image (Y), and performing image conversion using a generator GXY configured to convert the source domain image into the target domain image and a generator GYX configured to convert the target domain image into the source domain image;
calculating a total loss based on a loss function set for training the system; and
generating the trained image conversion model using the calculated total loss.

13. The method of claim 12, wherein setting the environment for training the image conversion model comprises:
setting training parameters; and
setting a target brightness for a result image.
